(19) United States
(12) Patent Application Publication
(10) Pub. No.: US 2008/0287332 A1
(43) Pub. Date: Nov. 20, 2008

(54) Method for Removing Etch Residue and Chemistry Therefor

(75) Inventor: Balgovind Sharma, Fishkill, NY (US)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 12/091,032

(22) PCT Filed: Oct. 21, 2005
(86) PCT No.: PCT/EP2005/013517

§ 371 Date: Apr. 21, 2008

(51) Int. Cl. C11D 7/00

(52) U.S. Cl. 510/175

(57) ABSTRACT

A method for cleaning, especially by removing etch residue (e.g., polymers or particles) from a semiconductor structure, and a cleaning chemistry is described. The method of cleaning includes placing the semiconductor structure with an etch residue particle on it in a chemistry to remove the particle, wherein the active component of the chemistry consists of a carboxylic acid having equal numbers of COOH and OH groups. In one embodiment, the carboxylic acid is tartaric acid. In one embodiment, the chemistry further comprises water.

### FIELD OF THE INVENTION

This invention relates generally to semiconductor structures, and more specifically, to cleaning semiconductor structures.

### BACKGROUND

When manufacturing a semiconductor device, various semiconductor structures are created by etching layers. During etching, etch residue, which is a polymer or particle, is created. For example, when etching to form a via the etch residue will be formed on the bottom and sidewalls of the via. Typically, the etch residues are organo-metallic polymers and include elements such as carbon, oxygen, fluorine, silicon, copper, hydrogen and nitrogen. The etch residues are undesirable because they contribute to low yield, high via resistance, via voids and other reliability issues. Therefore, there is a need to remove these etch residues.

In the industry, complex multi-component mixtures of ammonium fluoride, corrosion inhibitors, chelating agents, and complexing agents, are used to remove the undesirable etch residues. However these mixtures can react with underlying materials and create yield loss and result in poor electrical performance of the semiconductor device. In addition, these mixtures are expensive and thus, increase manufacturing costs. Thus, a need exists for a chemistry that removes etch residues created from etching, does not attack underlying layers, and is inexpensive.

### SUMMARY OF THE INVENTION

The present invention provides a method for removing etch residue from a semiconductor structure and a chemistry for use in such a method, as described in the accompanying claims.

### DETAILED DESCRIPTION OF THE PREFERRED EMBODIMENTS

The embodiments of the invention described below provide a simple and inexpensive chemistry to remove etch residue, which is particles or polymers that result from etching semiconductor structures, and includes only a single inexpensive active component. The chemistry is manufacturable because it is simple to create and inexpensive (e.g., less than US$30 per gallon). The chemistry improves yield and reliability. Furthermore, the chemistry can be used with semiconductor structures as they are scaled down.

Organic acids are desirable for removing etch residues. The carboxylic acids contain an acid or hydrophilic (COOH) and a hydrophobic component (C—H) and hence are well suited to remove post-etch residues. In particular most carboxylic acids are desirable for removing etch residues because they include both the organic component to dissolve the hydrocarbons of the etch residue and the polar acid COOH group that helps remove the charged or hydrophilic components of the etch residue. The presence of an acid (or carboxyl) group and hydrocarbon group further helps in chelating metals and passivating the metal surface or minimizing metal corrosion. In other words, carboxylic acids include a COOH group, which is hydrophilic, and a hydrocarbon group which is attracted to oil. In addition, some of these carboxylic acids (known as hydroxy carboxylic acids) may include an additional OH or alcohol group that enhances residue removal efficiency by dissolving or etching the residues and also aids in minimizing corrosion on metal surfaces. The presence of dual acid or carbonyl and alcohol groups (COOH and OH) can provide unique properties in removing etch residues and minimizing copper corrosion. Etch residue includes some parts that dissolve in water and other parts that dissolve in oil and thus, a carboxylic acid that has a COOH group, a hydrocarbon, and an OH group can be very effective in dissolving or etching all of the etch residue. In addition, COOH and OH groups can be very effective in chelating metal ions and passivating the metal surface. Some carboxylic acids are acetic, citric, oxalic, salicyclic, tartaric, glycolic, and phthalic acids. However, oxalic acid (H₂C₂O₄) does not include both a COOH group and an OH group and thus, may have limited cleaning efficiency, which may make oxalic acid an undesirable cleaning chemistry. More specifically, oxalic acid lacks any OH groups. The absence of OH group results in reduced dissolving, chelating, etching, and passivating power. In addition, because oxalic acid, shown below, does not have any alcohol or OH groups it has limited cleaning effectiveness

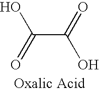

and thus another active component, such as surfactants, inorganic acids, amines, corrosion inhibitors, and chelating agents, is needed to effectively remove etch residues, minimize metal attack, passivate the metal surface, chelate metal ions, and enhance the cleaning efficiency. Thus, an additional active ingredient is needed to offset oxalic acid's lack of cleaning ability.

While any carboxylic acid with at least one COOH group and one OH group could be used to form an effective cleaning chemistry, many are not as efficient as tartaric acid. The inventor has discovered that tartaric acid alone is a very effective cleaning chemistry. Therefore, no other active components are necessary in the cleaning chemistry. Tartaric acid has an equal number of COOH and OH group and thus, any carboxylic acid that has an equal number of COOH and OH groups may be suitable. However, tartaric acid is a relatively inexpensive carboxylic acid that includes two COOH and OH groups and is thus, preferred for manufacturing. The presence of two COOH and OH group in tartaric acid provide better dissolving power as compared to single COOH and OH groups, such as glycolic, acetic, citric acid. Presence of two COOH and two OH groups in tartaric acid result in very effective cleaning efficiency. In addition, the presence of two COOH and two OH groups provide tartaric acid with strong dissolving, wetting, and dissolution properties that is targeted for the removal of post-etch residues (consisting of hydrocarbons and hydrophilic components). Tartaric acid, due to presence of two COOH and OH groups, chelates metal ions, removes oxides, passivates and protects the metal surface from corrosion, and provides a hydrophobic surface for robust barrier deposition resulting in yield improvement.

Tartaric acid has the formula of C₄H₆O₆ [(COOH—CH—OH)₂] and thus has 2 COOH and 2 OH groups. The chemical structure of tartaric acid can be shown as:

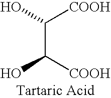

Other carboxylic acids do not have an OH group, such as oxalic acid as discussed above, or have either only one OH group, such as citric acid (C₆H₈O₇), or only one COOH group, such as acetic acid (C₂H₄O₂). While citric acid, shown below, and acetic acid, shown below, both have OH and COOH groups, their chemistries are not as desirable as tartaric

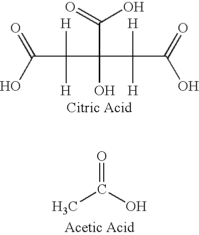

acid because they do not have as sufficient OH or COOH groups. Because citric acid has only one OH group it has limited dissolving, chelating, passivating, and cleaning efficiency. Similarly, because acetic acid has only one COOH group (and no OH group), it will be less effective in dissolving, cleaning, passivating, and chelating. Additional components such as surfactant, inorganic acids, amines, corrosion inhibitors, chelating agents and others may be required for effective cleaning for molecules that either lack or contain one OH or COOH group. In contrast, because tartaric acid has equal numbers of COOH and OH groups it is an ideal active chemistry (without any other active component added) that is very effective in chelating metal ions, passivating copper surface, dissolving, and cleaning etch residues.

Tartaric acid is a suitable cleaning chemistry and as described above no other active component is needed to remove etch residues. However, inactive component(s), such as water may be added. The water may be added to dilute the strength of the tartaric acid so that the final tartaric concentration is less than approximately 20% by weight. Preferably, the weight percent of the tartaric acid is between approximately 1 to 10 and the remaining component is water. Although not required, other inactive components that may be added are alcohols and glycols, or oliophilic reagents such as decane or decanols.

Thus, the mixture of tartaric acid (or any other carboxylic acid that has equal number of COOH and OH groups) and water can be used for cleaning, especially for removing etch residue on any surface. To clean the semiconductor structure, in one embodiment, a layer is formed over a semiconductor wafer. The semiconductor wafer can be any semiconductor material or combinations of materials, such as gallium arsenide, silicon germanium, silicon-on-insulator (SOI) (e.g., fully depleted SOI (FDSOI)), silicon, monocrystalline silicon, the like, and combinations of the above. Furthermore, the layer may be any layer. For example it may be a dielectric (e.g., a high dielectric constant dielectric), a metal (e.g., copper of aluminum), or a layer that includes silicon (e.g., silicide or polysilicon). In addition, the layer may be formed over other layers. These other layers may be a dielectric (e.g., a high dielectric constant dielectric), a metal (e.g., copper of aluminum), or a layer that includes silicon (e.g., silicide or polysilicon).

The layer is patterned by using conventional etching processes to form a semiconductor structure. For example, a via or trench may be formed in the layer or the layer may be patterned to form a gate electrode. During the etch process, etch residue is formed on the layer being patterned. If the layer being patterned forms a via or trench, the etch particles may be formed at the bottom or sidewalls of the via or trench. If the layer is patterned to form a gate electrode, etch residue may be formed on the sidewalls of the gate electrode and on the substantially horizontal surfaces of the layer that are formed next to the gate electrode after etching.

The etch residue is subsequently removed using a cleaning chemistry that includes any carboxylic acid that has equal numbers of COOH and OH groups and water. In one embodiment, the cleaning chemistry includes tartaric acid and water at a concentration range between approximately 1 to 10 weight %, or more preferably approximately 1 to 5 weight %, or more preferably approximately 5 weight %. Using this ratio of tartaric acid to water, the semiconductor structure may be exposed to the cleaning chemistry for approximately approximately 30 seconds to 4 minutes in a single wafer tool and approximately 3 to 10 minutes in a batch tool. However, one skilled in the art recognizes that the greater the tartaric acid concentration, the less time the semiconductor structure needs to be exposed to the cleaning chemistry. For example, if tartaric acid concentration is higher (great than approximately 5 weight % to 20 weight %) then the semiconductor structure may be exposed to the cleaning chemistry for only 20 seconds to 2 minutes in a single wafer tool and approximately 2 to 5 minutes in a batch tool. A concentration of approximately 1 to 5 weight % may be applied for approximately 1-4 minutes at room temperature, but at higher temperatures (approximately 25 to 45° C.), the exposure time may be reduced to less than approximately 2 minutes in a single wafer tool and less than approximately 5 minutes in a batch tool.

The cleaning chemistry may be applied to the semiconductor structure using any process. For example, the semiconductor wafer and structure may be dipped into the cleaning chemistry. Alternatively, the semiconductor wafer and structure may be sprayed with the cleaning chemistry. After applying the cleaning chemistry, the semiconductor wafer may be sprayed or put in water or dried using conventional processing. Tartaric acid can be dispensed onto the wafer using conventional techniques used for dispensing ordinary cleaning chemicals. Tartaric acid may be sprayed (or dispensed) onto the wafer for a period of approximately 30 seconds to 2 minutes in a single wafer tool and approximately 3 to 10 minutes in a batch tool. Next, the wafer may be rinsed in water, for approximately 30 seconds to 2 minutes in a single wafer tool or approximately 5 to 10 minutes in a batch tool. Afterwards, the wafer is dried. The rinsing and drying steps are substantially the same as those performed in conventional post-etch cleaning.

By now it should be appreciated that there has been provided a cleaning chemistry that in one embodiment is used for removing etch residue. The cleaning chemistry is most likely to be used to remove etch residue that is formed after etching vias or trenches. The chemistry is a simple one active component system and is thus, inexpensive simple, and easy to implement. Furthermore, this chemistry improves yield. The one active component system is preferable tartaric acid and will dissolve hydrocarbons and hydrophilic components of the residue, chelate metal ions, remove oxide on metal surface, and passivate the metal surface. Although the component system has only one active component it may include numerous inactive components. For example, it may include water.

More specifically, in one embodiment, a method for removing a particle from a semiconductor structure by providing a semiconductor structure with a particle on it is taught, wherein the method includes placing the semiconductor structure in a chemistry to remove the particle, wherein the chemistry consists essentially of a carboxylic acid having equal numbers of COOH and OH groups. In one embodiment, the carboxylic acid is tartaric acid. In one embodiment, the chemistry further includes water. In one embodiment, placing the semiconductor in a chemistry is performed for approximately 30 seconds to 10 minutes, or more specifically approximately 1 to 5 minutes. In one embodiment, placing the semiconductor in a chemistry further includes exposing the semiconductor in the chemistry at a temperature of approximately 25° C. In one embodiment, the method further includes forming the particle on the semiconductor structure, wherein the forming occurs by etching a layer on the semiconductor structure.

In one embodiment, a chemistry for removing a particle from a semiconductor structure is taught where, the chemistry consisting essentially of a carboxylic acid having equal numbers of COOH and OH groups. In one embodiment, the chemistry also includes water. In one embodiment, the carboxylic acid is tartaric acid. In one embodiment, the carboxylic acid has a concentration, and the concentration is between approximately 1 to 10 weight %.

In one embodiment, a method for removing a particle from a semiconductor structure is taught wherein the method includes providing a semiconductor structure with a particle on it, placing the semiconductor structure in a chemistry to remove the particle, wherein the chemistry consists of water and tartaric acid. In one embodiment, placing the semiconductor in a chemistry is performed for approximately 30 seconds to 10 minutes, or more specifically approximately 1 to 5 minutes. In one embodiment, placing the semiconductor in a chemistry further includes exposing the semiconductor in the chemistry at a temperature of approximately 25° C. In one embodiment, the method further includes forming the particle on the semiconductor structure, wherein forming the particle occurs by etching a layer on the semiconductor structure. In one embodiment, providing a semiconductor structure with a particle on it includes depositing a layer, patterning the layer, which in one embodiment may include forming a via or a trench, and forming a particle on the layer while patterning the layer.

In the foregoing specification, the invention has been described with reference to specific embodiments. However, one of ordinary skill in the art appreciates that various modifications and changes can be made without departing from the scope of the present invention as set forth in the claims below. Accordingly, the specification is to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms “a” or “an”, as used herein, are defined as one or more than one. Moreover, the terms “front”, “back”, “top”, “bottom”, “over”, “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

1. A method for removing etch residue from a semiconductor structure with the etch residue on it, the method comprising:
placing the semiconductor structure in a chemistry having an active component to remove the etch residue, wherein the active component consists of a carboxylic acid having equal numbers of COOH and OH groups.

2. The method of claim 1, wherein the carboxylic acid is tartaric acid.

3. The method of claim 1, wherein the chemistry further comprises water.

4. The method of claim 1, wherein placing the semiconductor in a chemistry is performed for approximately 30 seconds to 10 minutes.

5. The method of claim 1, wherein placing the semiconductor in a chemistry further comprises exposing the semiconductor in the chemistry at a temperature of approximately 25° C.

6. The method of claim 1, wherein forming the etch residue on the semiconductor structure by etching a layer on the semiconductor structure.

7. A chemistry having an active component for removing etch residue from a semiconductor structure, wherein the active component consists essentially of a carboxylic acid having equal numbers of COOH and OH groups.

8. The chemistry of claim 7, further including water.

9. The chemistry of claim 7, wherein the carboxylic acid is tartaric acid.

10. The chemistry of claim 7, wherein the carboxylic acid has a concentration of approximately 1 to 10 weight %.

11. The method of claim 2, wherein the chemistry further comprises water.

12. The method of claim 2, wherein placing the semiconductor in a chemistry is performed for approximately 30 seconds to 10 minutes.

13. The method of claim 2, wherein placing the semiconductor in a chemistry further comprises exposing the semiconductor in the chemistry at a temperature of approximately 25° C.

14. The method of claim 2, wherein forming the etch residue on the semiconductor structure by etching a layer on the semiconductor structure.

15. The method of claim 3, wherein placing the semiconductor in a chemistry is performed for approximately 30 seconds to 10 minutes.

16. The method of claim 4, wherein placing the semiconductor in a chemistry further comprises exposing the semiconductor in the chemistry at a temperature of approximately 25° C.

17. The method of claim 4, wherein forming the etch residue on the semiconductor structure by etching a layer on the semiconductor structure.

18. The chemistry of claim 8, wherein the carboxylic acid is tartaric acid.

19. The chemistry of claim 8, wherein the carboxylic acid has a concentration of approximately 1 to 10 weight %.

20. The chemistry of claim 9, wherein the carboxylic acid has a concentration of approximately 1 to 10 weight %.
